(19) United States
(12) Patent Application Publication
(10) Pub. No.: US 2025/0343565 A1
(43) Pub. Date: Nov. 6, 2025

(54) Signal Processing Method and Circuit, Chip, and Electronic Device

(71) Applicant: HUAWEI TECHNOLOGIES CO., LTD., Shenzhen (CN)

(72) Inventors: Jikang Xia, Shenzhen (CN); Ji Ding, Shanghai (CN); Jiang Chen, Shenzhen (CN); Jian Jiang, Shanghai (CN)

(73) Assignee: HUAWEI TECHNOLOGIES CO., LTD., Shenzhen (CN)

(21) Appl. No.: 19/271,195

(22) Filed: Jul. 16, 2025

Related U.S. Application Data
(63) Continuation of application No. PCT/CN2024/070422, filed on Jan. 3, 2024.

(30) Foreign Application Priority Data
Jan. 17, 2023 (CN) 202310096629.X

(51) Int. Cl. H04B 1/04; H04W 52/02

(52) U.S. Cl. CPC H04B 1/0475; H04W 52/0261

(57) ABSTRACT

After receiving a radio frequency signal that uses two frequencies to represent a digital signal 1 and a digital signal 0 respectively, a signal processing circuit filters out a high-frequency signal from the radio frequency signal and compares an envelope detection signal corresponding to a low-frequency signal with a reference signal to determine a digital signal corresponding to the radio frequency signal.

### CROSS-REFERENCE TO RELATED APPLICATIONS

This is a continuation of International Patent Application No. PCT/CN2024/070422, filed on Jan. 3, 2024, which claims priority to Chinese Patent Application No. 202310096629.X, filed on Jan. 17, 2023, both of which are incorporated by reference.

### TECHNICAL FIELD

This disclosure relates to the field of communication technologies, and in particular, to a signal processing method and circuit, a chip, and an electronic device.

### BACKGROUND

To reduce power consumption of an electronic device, modulation schemes in which signals of two frequencies are used to represent a digital signal 1 and a digital signal 0 respectively are widely applied, such as frequency-shift keying (FSK) modulation, and Gauss frequency-shift keying (GFSK) modulation. When a radio frequency signal obtained through modulation by using the foregoing modulation scheme is demodulated, a signal receiving circuit of the electronic device needs to process the signals of two frequencies to obtain a digital signal corresponding to the radio frequency signal. Consequently, power consumption of the signal receiving circuit of the electronic device is high.

### SUMMARY

In view of this, an embodiment of this disclosure provides a signal processing method and circuit, a chip, and an electronic device. A low-frequency signal in a radio frequency signal that represents a digital signal 1 and a digital signal 0 by using two signals of different frequencies is filtered out, to demodulate the radio frequency signal, thereby helping reduce power consumption of a signal processing circuit.

According to a first aspect, an embodiment of this disclosure provides a signal processing method, applied to an electronic device. The electronic device includes a signal processing circuit. The method includes: The signal processing circuit receives a radio frequency signal, where the radio frequency signal includes a first frequency signal and a second frequency signal, the first frequency signal and the second frequency signal correspond to different digital signals, and a first frequency is greater than a second frequency. The signal processing circuit performs frequency mixing on the radio frequency signal to obtain a mixed signal, where the mixed signal includes a third frequency signal corresponding to the first frequency signal and a fourth frequency signal corresponding to the second frequency signal. The signal processing circuit filters out the third frequency signal in the mixed signal to obtain a filtered signal, and obtains, based on the filtered signal, a digital signal corresponding to the radio frequency signal.

In other words, after performing frequency mixing on the radio frequency signal, the signal processing circuit in the electronic device filters out a high-frequency signal (the third frequency signal) from signals of two frequencies (the third frequency signal (for example, a signal of 510 kilohertz (kHz) mentioned below) and the fourth frequency signal (for example, a signal of 10 kHz mentioned below)) that are in the mixed signal and that represent digital signals, to obtain the filtered signal, and obtain, based on the filtered signal, the digital signal corresponding to the radio frequency signal. In this way, a signal processing frequency of the signal processing circuit is reduced, which helps reduce power consumption of the signal processing circuit and improve a battery life of the electronic device.

In a possible implementation of the first aspect, the electronic device further includes a Bluetooth communication unit, or Bluetooth communicator, and the method further includes: When information carried in the digital signal meets a wake-up condition, the signal processing circuit wakes up the Bluetooth communication unit or controls the Bluetooth communication unit to be powered on.

In other words, only when the information carried in the digital signal meets the wake-up condition, the signal processing circuit wakes up the Bluetooth communication unit or controls the Bluetooth communication unit to be powered on. In other words, when the information carried in the digital signal does not meet the wake-up condition, the Bluetooth communication unit is in a power-off or sleep state. This helps reduce power consumption of the Bluetooth communication unit, and further improve a battery life of the electronic device.

In a possible implementation of the first aspect, the wake-up condition includes any one of the following conditions: The information carried in the digital signal includes verification information that matches the electronic device; or the information carried in the digital signal includes verification information that matches the electronic device, and a distance between the electronic device and a vehicle that transmits the radio frequency signal is less than a first distance, where the verification information includes any one piece of the following information: a media access control address of the electronic device, a device serial number of the electronic device, a wake-up radio identifier of the electronic device, or a media access control address or a device serial number of the vehicle that transmits the radio frequency signal.

In a possible implementation of the first aspect, the method further includes: When it is determined that a power-off condition is met, the Bluetooth communication unit controls the Bluetooth communication unit to be powered off or enter a sleep state, and/or controls the signal processing circuit to be powered on or wakes up the signal processing circuit.

In a possible implementation of the first aspect, the power-off condition includes at least one of the following conditions: a received signal strength indicator of the radio frequency signal is less than a preset received signal strength indicator; a distance between the electronic device and a vehicle that transmits the radio frequency signal is greater than a second distance; and the electronic device does not detect a Bluetooth radio frequency signal or a Bluetooth low energy radio frequency signal.

In other words, when the power-off condition is met, the electronic device controls the Bluetooth communication unit to be powered off or enter the sleep state, and/or controls the signal processing circuit to be powered on or wakes up the signal processing circuit. In addition, the electronic device listens to a Bluetooth signal through the signal processing circuit, which helps improve a battery life of the electronic device.

In a possible implementation of the first aspect, the method further includes: When a distance between the electronic device and a vehicle that transmits the radio frequency signal is less than a third distance, the Bluetooth communication unit sends an unlock instruction to the vehicle; and/or when a distance between the electronic device and a vehicle that transmits the radio frequency signal is greater than a fourth distance, sends a lock instruction to the vehicle.

In other words, the electronic device may send the unlock instruction or the lock instruction to the vehicle based on the distance between the electronic device and the vehicle, so that the vehicle can automatically unlock or lock a vehicle door based on a received instruction, thereby improving user experience.

According to a second aspect, an embodiment of this disclosure provides a signal processing circuit. The signal processing circuit includes: a frequency mixer, an amplifier, a low-pass filter, an envelope detector, and a comparator, where an input end of the frequency mixer is configured to receive a radio frequency signal, an output end of the frequency mixer is connected to an input end of the amplifier, an output end of the amplifier is connected to an input end of the low-pass filter, an output end of the low-pass filter is connected to an input end of the detector, an output end of the envelope detector is connected to an input end of the comparator, and an output end of the comparator is configured to output a digital signal.

The frequency mixer is configured to: perform frequency mixing on the radio frequency signal and a local oscillator signal, and output a mixed signal, where the mixed signal includes a fifth frequency signal and a sixth frequency signal, the fifth frequency signal and the sixth frequency signal correspond to different digital signals, and a fifth frequency is greater than a sixth frequency. The amplifier is configured to: amplify the mixed signal, and output an amplified signal. The low-pass filter is configured to: filter the amplified signal, and output a filtered signal, where a cut-off frequency of the low-pass filter is less than the fifth frequency and greater than the sixth frequency. The envelope detector is configured to perform envelope detection on the filter signal to obtain an envelope signal. The comparator is configured to: compare the envelope signal with a reference signal, and output a digital signal corresponding to the radio frequency signal.

In other words, the signal processing circuit filters out a high-frequency signal from signals of two frequencies that are in the mixed signal and that represent a digital signal 1 and a digital signal 0, and compares an envelope detection signal corresponding to a low-frequency signal with the reference signal, to determine the digital signal corresponding to the radio frequency signal. In this way, the signal processing circuit may not need to process the high-frequency signal in the radio frequency signal. This helps reduce a quantity and power consumption of filters and envelope detectors, thereby reducing power consumption of the signal processing circuit.

In addition, because the amplifier is disposed behind the frequency mixer, the radio frequency signal may not need to be amplified. A frequency of the radio frequency signal is far higher than a frequency of a signal output by the frequency mixer, so that a signal processing frequency of the signal processing circuit is reduced, and power consumption of the signal processing circuit is reduced.

In some implementations, the frequency mixer, the amplifier, the low-pass filter, the envelope detector, and the comparator may be respectively a frequency mixer 22, an amplifier 23, a low-pass filter 24, an envelope detector 25, and a comparator 26 mentioned below. The fifth frequency signal and the sixth frequency signal may be respectively the third frequency signal and the fourth frequency signal mentioned below.

In a possible implementation of the second aspect, the fifth frequency signal corresponds to a digital signal 0, and the sixth frequency signal corresponds to a digital signal 1; or the fifth frequency signal corresponds to a digital signal 1, and the sixth frequency signal corresponds to a digital signal 0.

In a possible implementation of the second aspect, the radio frequency signal includes a radio frequency signal obtained through modulation by using a binary frequency shift keying scheme or a binary Gauss frequency shift keying scheme.

In a possible implementation of the second aspect, the radio frequency signal is a Bluetooth radio frequency signal or a Bluetooth low energy radio frequency signal.

In a possible implementation of the second aspect, a cut-off frequency of the low-pass filter is 250 kHz.

In a possible implementation of the second aspect, the comparator outputs a digital signal 1 when the envelope signal is greater than the reference signal, and outputs a digital signal 0 when the envelope signal is less than the reference electrical signal; or outputs a digital signal 0 when the envelope signal is greater than the reference signal, and outputs a digital signal 1 when the envelope signal is less than the reference electrical signal.

In a possible implementation of the second aspect, the envelope detector is an envelope detector corresponding to a binary on-off keying modulation scheme.

According to a third aspect, an embodiment of this disclosure provides an electronic device. The electronic device includes the signal processing circuit provided in any one of the second aspect and the possible implementations of the second aspect.

In a possible implementation of the third aspect, the electronic device further includes a Bluetooth communication unit and at least one processor, and the at least one processor is configured to: demodulate information carried in a digital signal, and when the information carried in the digital signal meets a wake-up condition, wake up the Bluetooth communication unit or control the Bluetooth communication unit to be powered on.

In other words, only when the information carried in the digital signal meets the wake-up condition, the signal processing circuit wakes up the Bluetooth communication unit or controls the Bluetooth communication unit to be powered on. However, when the information carried in the digital signal does not meet the wake-up condition, the Bluetooth communication unit is in a power-off or sleep state. This helps reduce power consumption of the Bluetooth communication unit and improve a battery life of the electronic device.

In a possible implementation of the third aspect, the wake-up condition includes any one of the following conditions: The information carried in the digital signal includes verification information that matches the electronic device; or the information carried in the digital signal includes verification information that matches the electronic device, and a distance between the electronic device and a vehicle that transmits the radio frequency signal is less than a fifth distance, where the verification information includes any one piece of the following information: a media access control address of the electronic device, a device serial number of the electronic device, a wake-up radio identifier of the electronic device, a media access control address of the vehicle, or a device serial number of the vehicle.

In a possible implementation of the third aspect, the at least one processor is further configured to: when the distance between the electronic device and the vehicle is less than a sixth distance, send an unlock instruction to the vehicle through the Bluetooth communication unit; and/or when the distance between the electronic device and the vehicle is greater than a seventh distance, send a lock instruction to the vehicle through the Bluetooth communication unit.

In a possible implementation of the third aspect, the at least one processor is further configured to: when it is determined that a power-off condition is met, control the Bluetooth communication unit to be powered off or enter a sleep state, and/or control the signal processing circuit to be powered on or wake up the signal processing circuit.

In a possible implementation of the third aspect, the power-off condition includes at least one of the following conditions: a received signal strength indicator of the radio frequency signal is less than a preset received signal strength indicator; a distance between the electronic device and a vehicle that transmits the radio frequency signal is greater than an eighth distance; and the electronic device does not detect a Bluetooth radio frequency signal or a Bluetooth low energy radio frequency signal.

According to a fourth aspect, an embodiment of this disclosure provides a chip. The chip includes the signal processing circuit provided in any one of the second aspect or the possible implementations of the second aspect.

It may be understood that, for beneficial effects of the second aspect to the fourth aspect, refer to the descriptions of the first aspect. Details are not described herein again.

### BRIEF DESCRIPTION OF DRAWINGS

FIG. 1 is a diagram of modulating a digital signal by using different schemes according to some embodiments of this disclosure.

FIG. 2 is a diagram of a signal processing circuit 00 according to some embodiments of this disclosure.

FIG. 3 is a diagram of a signal processing circuit 20 according to some embodiments of this disclosure.

FIG. 4A and FIG. 4B are diagrams of a process in which a signal processing circuit 20 processes a signal according to some embodiments of this disclosure.

FIG. 5 is a diagram of a structure of a smartwatch 1 according to some embodiments of this disclosure.

FIG. 6A is a diagram of a passive keyless unlock scenario of a vehicle according to some embodiments of this disclosure.

FIG. 6B is a diagram of another passive keyless unlock scenario of a vehicle according to some embodiments of this disclosure.

FIG. 6C is a diagram of a passive keyless lock scenario of a vehicle according to some embodiments of this disclosure.

FIG. 7A and FIG. 7B are a schematic interaction flowchart of a passive keyless unlock/lock method according to some embodiments of this disclosure.

FIG. 8 is a diagram of embedding verification information into a Bluetooth broadcast frame according to some embodiments of this disclosure.

FIG. 9A and FIG. 9B are a schematic interaction flowchart of another passive keyless unlock/lock method according to some embodiments of this disclosure.

FIG. 10 is a diagram of a structure of an electronic vehicle key 200 according to some embodiments of this disclosure.

### DETAILED DESCRIPTION

Illustrative embodiments of this disclosure include but are not limited to a signal processing method and circuit, a chip, and an electronic device.

For ease of understanding, terms used in embodiments of this disclosure are first briefly described.

### (1) FSK

FSK is a modulation scheme used early in information transmission, which uses a plurality of frequencies to represent different digital signals or digital signal combinations.

For example, FSK of two frequencies (2FSK), also referred to as binary frequency shift keying, uses signals of two different frequencies to represent a digital signal 1 and a digital signal 0 respectively. For another example, FSK of four frequencies uses signals of four different frequencies to represent digital signal combinations 00, 01, 10, and 11 respectively.

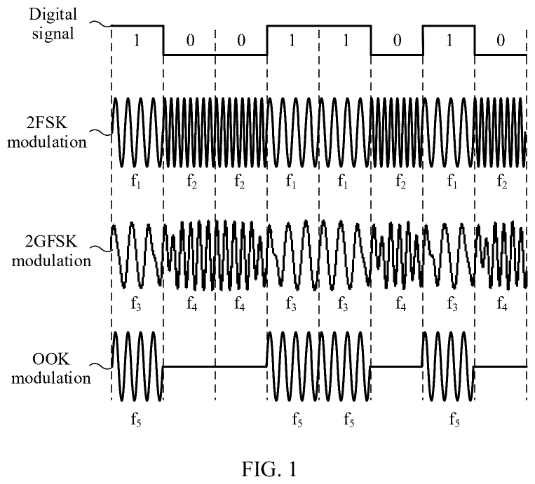

Referring to FIG. 1, a radio frequency signal obtained by modulating a digital signal 10011010 using 2FSK uses a signal of frequency f₁ to represent the digital signal 1 and a signal of frequency f₂ to represent the digital signal 0, where f₁<f₂. In other words, in eight consecutive signal periods, frequencies of signals in the periods in the radio frequency signal obtained by modulating the digital signal 10011010 are f₁, f₂, f₂, f₁, f₁, f₂, f₁, and f₂ sequentially.

### (2) GFSK

GFSK is a modulation scheme in which a Gauss low-pass filter is added to limit a spectrum width of a signal before FSK modulation is performed on the signal, to increase a concentration degree of a power spectrum of a radio frequency signal obtained through modulation, and reduce power consumption of a signal transmitting circuit and a signal receiving circuit of a radio frequency signal obtained through modulation by using a GFSK modulation scheme. GFSK also uses a plurality of frequencies to represent different digital signals or digital signal combinations.

For example, GFSK of two frequencies (2GFSK), also referred to as binary Gauss frequency shift keying, uses signals of two different frequencies to represent a digital signal 1 and a digital signal 0 respectively. For another example, 4GFSK of four frequencies uses signals of four different frequencies to represent digital signal combinations 00, 01, 10, and 11 respectively.

Referring to FIG. 1, a radio frequency signal obtained by modulating a digital signal 10011010 using 2GFSK uses a signal of frequency f₃ to represent the digital signal 1 and a signal of frequency f₄ to represent the digital signal 0, where f₃<f₄. In other words, in eight consecutive signal periods, frequencies of signals in the periods in the radio frequency signal obtained by modulating the digital signal 10011010 are f₃, f₄, f₄, f₃, f₃, f₄, f₃, and f₄ sequentially.

### (3) Binary On-Off Keying (OOK)

OOK is a modulation scheme in which only a signal of one frequency is used to represent a digital signal 1. For example, refer to FIG. 1. A radio frequency signal obtained by modulating a digital signal 10011010 using OOK uses a signal of frequency f₅ to represent the digital signal 1. In other words, in eight consecutive signal periods, frequencies of signals in the periods in the radio frequency signal obtained by modulating the digital signal 10011010 are f₅, 0 (no signal), 0 (no signal), f₅, f₅, 0 (no signal), f₅, and 0 (no signal) sequentially.

The following describes the technical solutions in embodiments of this disclosure with reference to the accompanying drawings.

It may be understood that the signal processing circuit provided in embodiments of this disclosure is applicable to a case in which any radio frequency signal that uses two frequencies to represent a digital signal 1 and a digital signal 0 is processed, including but not limited to a case in which a radio frequency signal, for example, a Bluetooth radio frequency signal or a Bluetooth Low Energy (BLE) radio frequency signal, obtained through modulation by using a 2FSK modulation scheme, a 2GFSK modulation scheme, or an OOK modulation scheme is processed. For ease of description, the following uses the BLE radio frequency signal obtained through modulation by using the 2GFSK scheme as an example to describe the technical solutions in embodiments of this disclosure.

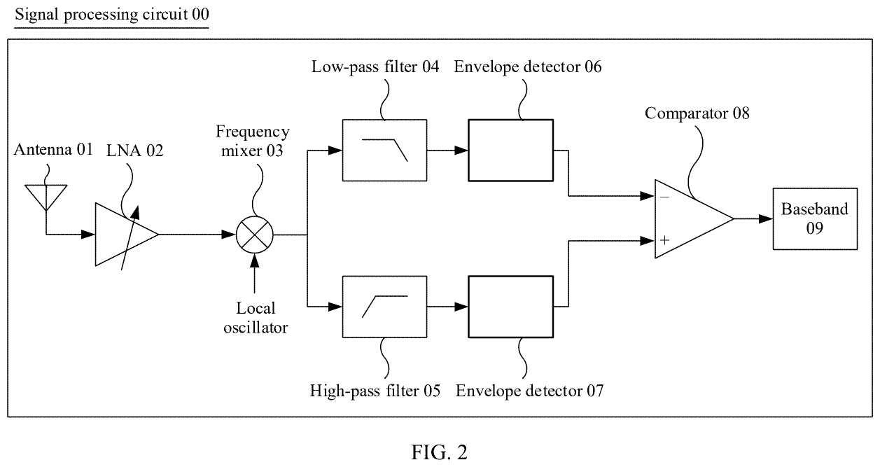

Because the BLE radio frequency signal obtained through modulation by using 2GFSK includes signals of two frequencies (for example, a first frequency signal and a second frequency signal, where a first frequency is higher than a second frequency), one frequency signal represents a digital signal 1, and the other frequency signal represents a digital signal 0. Further, refer to FIG. 2. In some embodiments, a signal receiving circuit 00 for the BLE radio frequency signal includes an antenna 01, a low-noise amplifier (LNA) 02, a frequency mixer 03, a low-pass filter 04, a high-pass filter 05, an envelope detector 06, an envelope detector 07, a comparator 08, and a baseband 09. The antenna 01 is configured to receive the BLE radio frequency signal, and an output end of the antenna 01 is connected to an input end of the LNA 02. An output end of the LNA 02 is connected to an input end of the frequency mixer 03. An output end of the frequency mixer 03 is connected to an input end of the low-pass filter 04 and an input end of the high-pass filter 05. An output end of the low-pass filter 04 and an output end of the high-pass filter 05 are connected to an input end of the envelope detector 06 and an input end of the envelope detector 07 respectively. An output end of the envelope detector 06 and an output end of the envelope detector 07 are connected to an input end of the comparator 08 respectively, and an output end of the comparator 08 is connected to the baseband 09.

After receiving the BLE radio frequency signal output by the antenna 01, the LNA 02 amplifies the radio frequency signal, and outputs an amplified signal to the frequency mixer 03.

The frequency mixer 03 performs frequency mixing on the amplified signal and a local oscillator signal of the signal receiving circuit 00 to obtain a low-frequency mixed signal, and separately outputs the mixed signal to the low-pass filter 04 and the high-pass filter 05. The mixed signal includes a third frequency signal and a fourth frequency signal, the third frequency signal corresponds to the first frequency signal, the fourth frequency signal corresponds to the second frequency signal, and a third frequency is greater than a fourth frequency.

The low-pass filter 04 is configured to: filter out the third frequency signal from the mixed signal to obtain a first filtered signal, and output the first filtered signal to the envelope detector 06.

The high-pass filter 05 is configured to: filter out the fourth frequency signal from the mixed signal to obtain a second filtered signal, and output the second filtered signal to the envelope detector 07.

The envelope detector 06 is configured to: perform envelope detection on the first filtered signal, and output a detected first envelope signal to the comparator 08.

The envelope detector 07 is configured to: perform envelope detection on the second filtered signal, and output a detected second envelope signal to the comparator 08.

The comparator 08 is configured to: compare the first envelope signal with the second envelope signal, and output a digital signal 1 when the first envelope signal is greater than the second envelope signal, or output a digital signal 0 when the first envelope signal is less than the second envelope signal.

The baseband 09 is configured to demodulate, according to a Bluetooth transmission protocol, a digital signal output by the comparator 08, to obtain information carried in the digital signal.

Power consumption of an amplifier, a filter, an envelope detector, and the like increases with a frequency of a processed signal. In the signal receiving circuit 00, the LNA 02 is disposed in front of the frequency mixer 03, and directly amplifies a radio frequency signal. Because a frequency of the radio frequency signal is high (a frequency of a Bluetooth radio frequency signal or a BLE radio frequency signal obtained through modulation by using 2GFSK is in a 2.4 GHz frequency band), power consumption of the LNA 02 is high. In addition, because the third frequency signal may need to be processed by using the high-pass filter 05 and the envelope detector 07, power consumption of the high-pass filter 05 and the envelope detector 07 is also high. Further, power consumption of the signal receiving circuit 00 shown in FIG. 2 is high, which is not conducive to reducing power consumption of an electronic device that uses the signal receiving circuit 00.

In view of this, an embodiment of this disclosure provides a signal processing circuit, configured to process a radio frequency signal that uses two frequencies to indicate a digital signal 1 and a digital signal 0 respectively. The signal processing circuit filters out a high-frequency signal from signals of two frequencies that are in the radio frequency signal and that represent the digital signal 1 and the digital signal 0, and compares an envelope detection signal corresponding to a low-frequency signal with the reference signal, to determine the digital signal corresponding to the radio frequency signal. In this way, the signal processing circuit may not need to process the high-frequency signal in the radio frequency signal. This helps reduce a quantity and power consumption of filters and envelope detectors, thereby reducing power consumption of the signal processing circuit.

In addition, in some embodiments, the LNA 02 in the signal receiving circuit 00 may not be disposed, but an amplifier is disposed behind the frequency mixer, so that amplification of a high-frequency radio frequency signal can be avoided, and power consumption of the signal processing circuit can be further reduced.

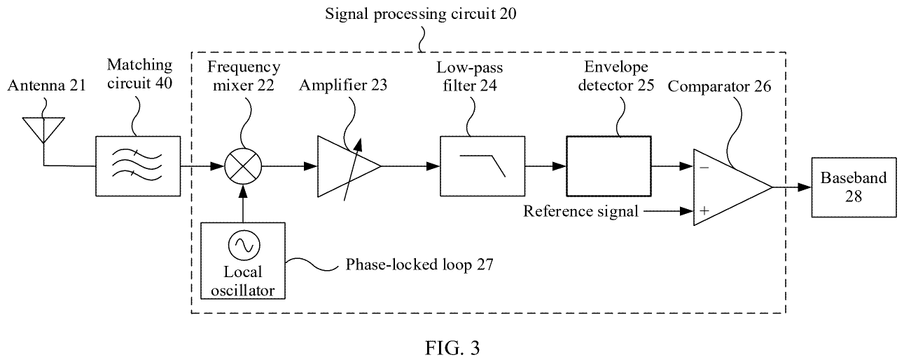

FIG. 3 is a diagram of a structure of a signal processing circuit 20 according to some embodiments of this disclosure.

As shown in FIG. 3, the signal processing circuit 20 includes a frequency mixer 22, an amplifier 23, a low-pass filter 24, an envelope detector 25, a comparator 26, and a phase-locked loop 27. An input end of the frequency mixer 22 is connected to the antenna 21 through a matching circuit 40, and is configured to receive a BLE radio frequency signal. The other input end of the frequency mixer 22 is connected to an output end of the phase-locked loop 27, and an output end of the frequency mixer 22 is connected to an input end of the amplifier 23. An output end of the amplifier 23 is connected to an input end of the low-pass filter 24. An output end of the low-pass filter 24 is connected to an input end of the envelope detector 25. An output end of the envelope detector 25 is connected to an input end of the comparator 26, an output end of the comparator 26 is connected to the baseband 28, and the other input end of the comparator 26 is configured to receive a reference signal.

The antenna 21 is configured to receive the BLE radio frequency signal.

The matching circuit 40 is configured to match impedance between the antenna 21 and the signal processing circuit 20, to reduce signal reflection interference.

The frequency mixer 22 is configured to: perform frequency mixing on the BLE radio frequency signal received by the antenna 21 and a local oscillator signal of the signal processing circuit 20 (that is, an offset is added to a frequency of the radio frequency signal, so that a signal obtained through frequency mixing can maintain a feature of the signal, and can reduce a frequency of the signal), to obtain a low-frequency mixed signal, and output the mixed signal to the amplifier 23. The mixed signal includes a third frequency signal and a fourth frequency signal, where a third frequency is higher than a fourth frequency.

For example, for a BLE radio frequency signal, it is assumed that a center frequency of the BLE radio frequency signal obtained through modulation is 2402 megahertz (MHz), and a modulation index is 0.5 (a corresponding frequency deviation is 250 kHz, namely, a value of frequencies of signals representing 0 and 1 that deviate from the center frequency). In this case, the radio frequency signal includes a signal of frequency 2402.25 MHz (indicates the digital signal 0) and a signal of frequency 2401.75 MHz (indicates the digital signal 1). Therefore, a frequency difference between the signal indicating the digital signal 1 and the signal indicating the digital signal 0 in the radio frequency signal is 500 kHz. It is assumed that a frequency deviation of the frequency mixer 22 is 2401.74 MHz. In this case, in the mixed signal output by the frequency mixer 22, a signal of 10 kHz (the fourth frequency signal) corresponds to a signal of frequency 2401.75 MHz in the BLE radio frequency signal, and represents the digital signal 1; and in the mixed signal output by the frequency mixer 22, a signal of 510 kHz (the third frequency signal) corresponds to a signal of frequency 2402.25 MHz in the BLE radio frequency signal, and represents the digital signal 0.

It may be understood that in some other embodiments, the fourth frequency signal may represent the digital signal 0, and the third frequency signal may represent the digital signal 1. This is not limited herein.

It may be understood that, the introduction of the technical solutions in this disclosure by using a radio frequency signal whose center frequency is 2402 MHz (that is, a channel 37 in the Bluetooth transmission protocol) as an example is merely an example. In some other embodiments, the BLE radio frequency signal may be another radio frequency signal whose center frequency is another frequency, for example, a radio frequency signal whose center frequency is 2426 MHz and that corresponds to a channel 38 in the Bluetooth transmission protocol, or a radio frequency signal whose center frequency is 2480 MHz and that corresponds to a channel 39 in the Bluetooth transmission protocol.

The amplifier 23 is configured to: amplify the mixed signal, and output an obtained amplified signal to the low-pass filter 24. In some embodiments, a frequency component of the amplified signal is the same as that of the mixed signal, but with a different amplitude.

The low-pass filter 24 is configured to: filter out the third frequency signal from the amplified signal to obtain a low-pass filtered signal, and output the low-pass filtered signal to the envelope detector 06. A cut-off frequency of the low-pass filter 04 is between the third frequency and the fourth frequency.

It may be understood that, because a rate generally used by the BLE radio frequency signal is 1 Mbps, and a corresponding modulation index is between 0.45 and 0.55 (a corresponding frequency deviation is between 225 kHz and 275 kHz), a sum of frequency deviations of the digital signal 0 and the digital signal 1 is 450 kHz to 550 kHz. Therefore, in some embodiments, the cut-off frequency of the low-pass filter 04 may be 250 kHz.

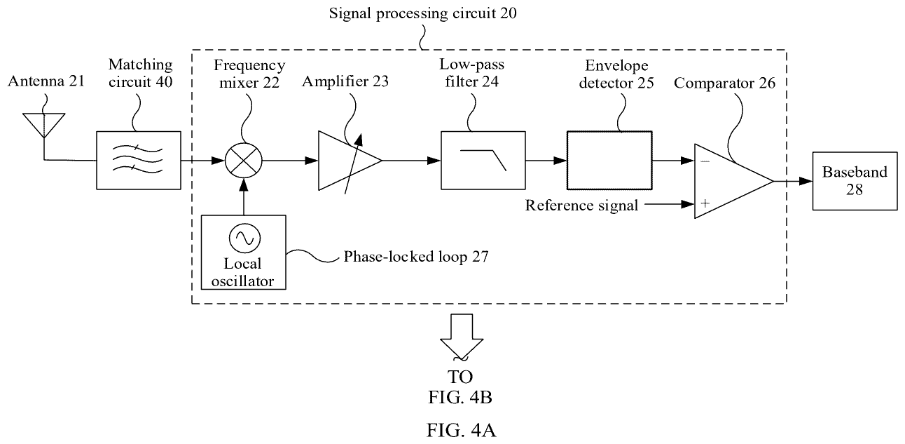

For example, refer to FIG. 4A and FIG. 4B. It is assumed that the signal output by the amplifier 23 includes a signal of frequency 10 kHz and a signal of frequency 510 kHz. After the amplified signal is input to the low-pass filter 24, the low-pass filter may filter out the signal of frequency 510 kHz, and reserve the signal of frequency 10 kHz.

The envelope detector 25 is configured to: perform envelope detection on the low-pass filtered signal, and output a detected envelope signal to the comparator 26.

It may be understood that, in some embodiments, envelope detection is also referred to as envelope-demodulation, and the envelope signal output by the envelope detector 25 may indicate a connection line of a peak value of the low-pass filtered signal.

It may be understood that, in some embodiments, the low-pass filtered signal only uses the fourth frequency signal to represent the digital signal 1, which is the same as a signal obtained through modulation by using an OOK scheme. Therefore, the envelope detector 25 may be an envelope detector corresponding to the radio frequency signal obtained through modulation by using the OOK scheme.

It may be understood that, in some embodiments, the envelope detector 25 is an envelope detector implemented through an analog circuit or a digital circuit.

For example, refer to FIG. 4A and FIG. 4B. A waveform of the envelope signal obtained by performing, by the envelope detector 25, envelope detection on the low-pass filtered signal input by the low-pass filter 24 may reflect a connection line L of the peak value of the low-pass filtered signal.

The comparator 26 is configured to: compare the envelope signal with the reference signal, and output the digital signal 1 when the envelope signal is greater than the reference signal, or output the digital signal 0 when the envelope signal is less than the reference signal.

For example, refer to FIG. 4A and FIG. 4B. In the T1 period, the T4 period, the T5 period, and the T7 period, the envelope signal is greater than the reference signal, and the comparator 26 outputs the digital signal 1. In the T2 period, the T3 period, the T6 period, and the T8 period, the envelope signal is less than the reference signal, and the comparator 26 outputs the digital signal 0.

It may be understood that, in some other embodiments, the BLE radio frequency signal may alternatively use the third frequency to represent the digital signal 1, and use a low frequency to represent the digital signal 0. The comparator 26 may be further configured to: compare the envelope signal with the reference signal, and output the digital signal 0 when the envelope signal is greater than the reference signal, or output the digital signal 1 when the envelope signal is less than the reference signal.

It may be understood that, in some embodiments, the comparator 26 is a comparator 26 implemented through an analog circuit or a digital circuit.

The baseband 28 is configured to demodulate, according to a Bluetooth transmission protocol, a digital signal output by the comparator 26, to obtain information included in the digital signal.

The phase-locked loop 27 is configured to: add a frequency of a fixed frequency deviation (for example, 350 kHz) to a center frequency of the BLE radio frequency signal, so that a frequency range of the signal output by the frequency mixer 22 is smaller, to further reduce power consumption of components such as the amplifier 23, the low-pass filter 24, and the envelope detector 25 that are disposed behind the frequency mixer 22.

Based on the signal processing circuit 20, because the amplifier 23 is disposed behind the frequency mixer 22, amplification of a high-frequency radio frequency signal can be avoided. This helps reduce power consumption of the signal processing circuit 20. In addition, the signal processing circuit 20 filters out a high-frequency signal by using the low-pass filter 24, so that the low-pass filter may only need to process a signal within the cut-off frequency of the low-pass filter 24, which is equivalent to converting a signal obtained through modulation by using 2GFSK into a signal obtained through modulation by using the OOK modulation scheme, and may not need to process a high-frequency signal in the signal obtained through modulation by using 2GFSK. This reduces a quantity of filters and envelope detectors, and further reduces power consumption of the signal processing circuit 20 because a signal processed by the signal processing circuit 20 is a low-frequency signal.

It may be understood that, in some other embodiments, the signal processing circuit 20 may alternatively include more or fewer components. This is not limited herein. For example, the signal processing circuit 20 may not include the phase-locked loop 27. For another example, one or more of the antenna 21, the matching circuit 40, and the baseband 28 may be disposed in the signal processing circuit 20.

It may be understood that the signal processing circuit 20 may be used in any scenario in which the radio frequency signal that uses two frequencies to represent the digital signal 1 and the digital signal 0 respectively is to be received. For example, the signal processing circuit 20 may be used in any electronic device that may need to receive a Bluetooth radio frequency signal or a BLE radio frequency signal, including but not limited to a mobile phone, a wearable device (such as a smartwatch or a smart band), a tablet computer, an internet of things device, a smart home device, an electronic vehicle key, and the like. The following describes the technical solutions in embodiments of this disclosure by using an example in which the signal processing circuit 20 is disposed in the smartwatch 1 and a disclosure scenario is a passive keyless unlock/lock scenario of a vehicle 2.

For ease of understanding, a hardware structure of the smartwatch 1 is first described.

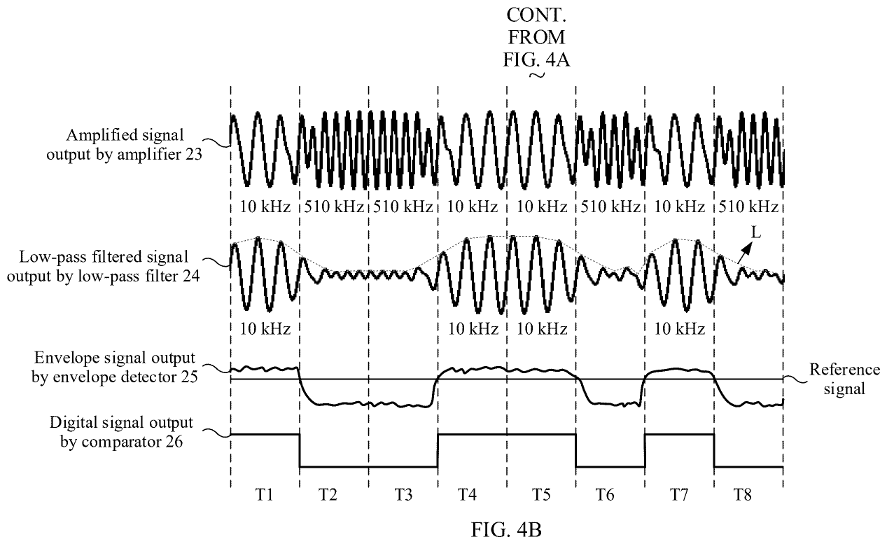

FIG. 5 is a diagram of a structure of a smartwatch 1 according to some embodiments of this disclosure.

As shown in FIG. 5, the smartwatch 1 includes a processor 10, a signal processing circuit 20, a Bluetooth communication unit 30, a matching circuit 40, an antenna 21, a power supply 50, a memory 60, a display 70, a button 80, a sensor unit 90, and the like.

The processor 10 may include one or more processing units, for example, may include a processing module or a processing circuit of a central processing unit (CPU), a graphics processing unit (GPU), a digital signal processor (DSP), an artificial intelligence (AI) processor or a programmable logic device (e.g., a field-programmable gate array (FPGA)), a microcontroller unit (MCU), or an application-specific integrated circuit (ASIC). Different processing units may be independent components, or may be integrated into one or more processors.

The signal processing circuit 20 is configured to: receive a radio frequency signal (for example, a BLE radio frequency signal or a Bluetooth radio frequency signal) through the antenna 21, and perform frequency mixing, amplification, low-pass filtering, envelope detection, comparison, and demodulation on the radio frequency signal, to obtain information carried in the radio frequency signal. For example, in some embodiments, the signal processing circuit 20 may include the frequency mixer 22, the amplifier 23, the low-pass filter 24, the envelope detector 25, the comparator 26, the phase-locked loop 27, and the baseband 28. In some embodiments, the signal processing circuit 20 may also be referred to as wake-up radio (WUR).

The Bluetooth communication unit 30 is configured to implement Bluetooth communication between the smartwatch 1 and another electronic device. A wireless communication module may be one or more components integrating at least one communication processing module. The Bluetooth communication unit 30 receives an electromagnetic wave through the antenna 21, performs frequency modulation and filtering on an electromagnetic wave signal, and sends a processed signal to the processor 10. The Bluetooth communication unit 20 may further receive a to-be-sent signal from the processor 10, perform frequency modulation and amplification on the signal, and convert a processed signal into an electromagnetic wave for radiation through the antenna 21. In some embodiments, the Bluetooth communication unit 30 may be BLE, to reduce power consumption of the Bluetooth communication unit 30.

It may be understood that the Bluetooth communication unit 30 may include at least any one of various implementations of an existing Bluetooth standard, BLE, a future implementation of the Bluetooth standard, and the like. For example, the Bluetooth communication unit 30 may be any Bluetooth communication unit based on a Bluetooth protocol 2.x, a Bluetooth protocol 3.x, a Bluetooth protocol 4.x, a Bluetooth protocol 5.x, or BLE. In some embodiments, the Bluetooth communication unit 30 and the processor 10 transmit data through a universal asynchronous receiver transmitter (UART), and implement a Bluetooth function based on an instruction of the processor 10. A UART interface is a universal serial data bus used for asynchronous communication. The bus may be a bidirectional communication bus, and converts to-be-transmitted data between serial communication and parallel communication.

The matching circuit 40 is configured to implement impedance matching between the antenna 21 and the signal processing circuit 20 or between the antenna 21 and the Bluetooth communication unit 30.

The antenna 21 is configured to: receive an electromagnetic wave, and transmit the received electromagnetic wave to a corresponding module (for example, the signal processing circuit 20 or the Bluetooth communication unit 30); or receive a signal from the signal processing circuit 20 or the Bluetooth communication unit 30 and transmit the signal through the electromagnetic wave.

The power supply 50 may include a battery. The power supply 50 may be configured to charge the battery, or supply power to the processor 10, the signal processing circuit 20, the Bluetooth communication unit 30, the matching circuit 40, the antenna 21, the memory 60, the display 70, the button 80, the sensor unit 90, and the like.

The memory 60 may include a volatile memory such as a random-access memory (RAM) or a double data rate synchronous dynamic random-access memory (DDR SDRAM), and a non-volatile memory such as a programmable read-only memory (PROM), an electrically alterable read-only memory (EAROM), an erasable programmable read-only memory (EPROM), an electrically erasable programmable read-only memory (EEPROM), a flash memory, or a secure digital (SD) memory card. The memory 60 may be configured to store instructions and data.

The display 70 is configured to display an image, a video, or the like, for example, a desktop or a GUI of each application. The display 204 includes a display panel. The display panel may be a liquid-crystal display (LCD), an organic light-emitting diode (OLED), an active-matrix organic light-emitting diode (AMOLED), a flexible light-emitting diode (FLED), a mini-LED, a micro-LED, a micro-OLED, a quantum dot light-emitting diode (QLED), or the like.

In some embodiments, the display 70 may be further integrated with a touch sensor to form a touchscreen, so that a user can interact with the smartwatch 1 through a touch operation.

The button 80 may include a watch crown, a watch face, and the like, and is configured to send a signal to the processor 10 when an operation performed by the user on the button 80 is detected, to trigger a corresponding function.

The sensor unit 90 may be configured to monitor a status of the smartwatch 1 or a status of wearing the smartwatch 1. In some embodiments, the sensor module 90 may include: a temperature sensor, configured to detect an ambient temperature of an environment in which the smartwatch 1 is located; a blood pressure sensor, configured to detect blood pressure of a user wearing the smartwatch 1; a heart rate sensor, configured to detect a heart rate of the user wearing the smartwatch 1; and an acceleration sensor, configured to detect a magnitude of acceleration in each direction (generally three axes), a posture of the smartwatch 1, motion data of the user wearing the smartwatch 1, or the like.

In some embodiments, the smartwatch 1 may further include an interface module, and the interface module may include a physical interface configured to connect to another electronic device, for example, an interface configured to connect to an external memory card (for example, an SD card interface configured to connect to a micro SD card), or a universal serial bus (USB) interface configured to connect to another device.

It may be understood that a structure of the smartwatch 1 shown in FIG. 5 does not constitute an example limitation on the smartwatch 1. In some other embodiments of this disclosure, the smartwatch 1 may include more or fewer components than those shown in the figure, or some components may be combined, or some components may be split, or there may be a different component arrangement. The components shown in the figure may be implemented by hardware, software, or a combination of software and hardware.

The following describes the technical solutions in embodiments of this disclosure with reference to a structure of the smartwatch 1.

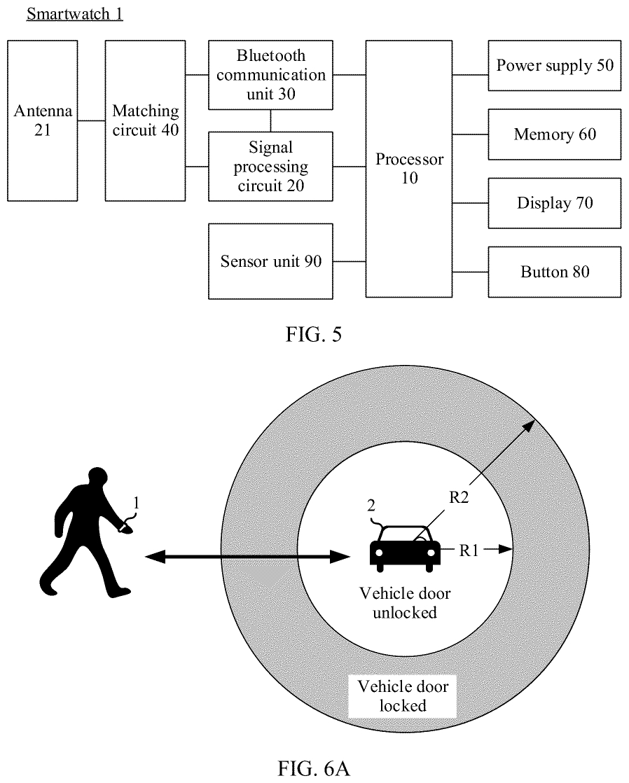

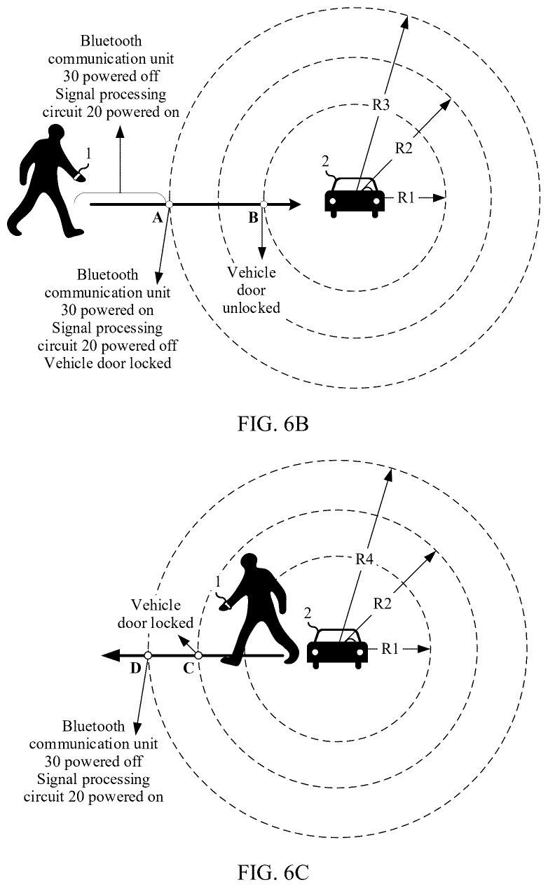

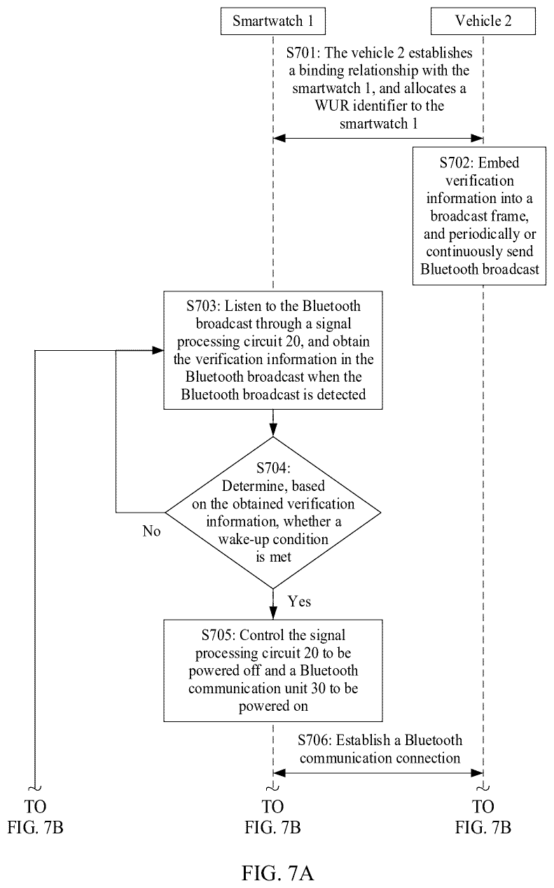

FIG. 6A is a diagram of a passive keyless unlock scenario of a vehicle according to some embodiments of this disclosure.

Refer to FIG. 6A. After a smartwatch 1 is paired with a vehicle 2, when detecting that a distance between a user and the vehicle 2 is less than R1, the smartwatch 1 interacts with the vehicle 2 through a Bluetooth communication unit 30, to send an unlock instruction to the vehicle 2. After receiving the unlock instruction, the vehicle 2 unlocks a vehicle door. When detecting that the distance between the user and the vehicle 2 is greater than R1, the smartwatch 1 interacts with the vehicle 2 through the Bluetooth communication unit 3, to send a lock instruction to the vehicle 2. After receiving the lock instruction, the vehicle 2 locks the vehicle door.

To reduce power consumption of the smartwatch 1, in some embodiments, when the Bluetooth communication unit 30 may not need to interact with the vehicle 2, the smartwatch 1 may control the Bluetooth communication unit 30 to be powered off or enter a sleep state, and receive a Bluetooth radio frequency signal of the vehicle 2 through the signal processing circuit 20.

For example, refer to FIG. 6B. When the user who carries the smartwatch 1 approaches the vehicle 2, before the user arrives at point A, the Bluetooth communication unit 30 is powered off or enters a sleep state, and the signal processing circuit 20 is powered on and listens to Bluetooth broadcast. When the user who carries the smartwatch 1 is at point A in FIG. 6B, a distance between the smartwatch 1 and the vehicle 2 is less than a wake-up distance R3, and the signal processing circuit 20 detects the Bluetooth broadcast of the vehicle 2. When it is determined that a wake-up condition is met (for example, when verification information carried in the Bluetooth broadcast matches the smartwatch 1), the smartwatch 1 controls the Bluetooth communication unit 30 to be powered on or wake up the Bluetooth communication unit 30, and the signal processing circuit 20 is powered off or enters a sleep state. In this way, the smartwatch 1 may interact with the vehicle 2 through the Bluetooth communication unit 30, and when it is detected that an unlock condition is met (for example, when the distance between the smartwatch 1 and the vehicle 2 is less than the unlock distance R1, that is, the user is located at point B in FIG. 6B), the smartwatch 1 sends the unlock instruction to the vehicle 2, and the vehicle 2 controls, in response to the unlock instruction, the vehicle door to be unlocked.

It may be understood that, in some embodiments, the wake-up condition may include any one of the following conditions:

The verification information carried in the Bluetooth broadcast received by the smartwatch 1 matches the smartwatch 1.

The verification information carried in the Bluetooth broadcast received by the smartwatch 1 matches the smartwatch 1, and the distance between the smartwatch 1 and the vehicle 2 is less than the wake-up distance R3.

It may be understood that the verification information may include at least one piece of the following information: identification information of the smartwatch 1, for example, a media access control (MAC) address of the smartwatch 1, a device serial number of the smartwatch 1, a WUR identifier of the smartwatch 1, and the like; and identification information of the vehicle 2, for example, a MAC address of the vehicle 2, a device serial number of the vehicle 2, and the like.

It may be understood that, in some embodiments, the unlock condition may include that the distance between the smartwatch 1 and the vehicle 2 is less than the unlock distance R1.

For another example, refer to FIG. 6C. When the user who carries the smartwatch 1 moves away from the vehicle 2, the smartwatch 1 interacts with the vehicle 2 through the Bluetooth communication unit 30, and when it is determined that a lock condition is met (for example, when the distance between the smartwatch 1 and the vehicle 2 is greater than a lock distance R2, that is, the user is located at point C in FIG. 6C), sends a lock instruction to the vehicle 2, so that the vehicle 2 controls, in response to the lock instruction, the vehicle to be locked. In addition, when it is determined that a power-off condition is met (for example, when the distance between the smartwatch 1 and the vehicle is less than a power-off distance R4, that is, the user is located at point D in FIG. 6C), the smartwatch 1 controls the Bluetooth communication unit 30 to be powered off or enter a sleep state, and controls the signal processing circuit 20 to be powered on, and the signal processing circuit 20 listens to the Bluetooth broadcast or BLE broadcast.

In embodiments shown in FIG. 6B and FIG. 6C, when the wake-up condition is not met or the power-off condition is met, the Bluetooth communication unit 30 is in a sleep state or powered off, and power consumption of the signal processing circuit 20 is low. This helps reduce power consumption of the smartwatch 1 and improve a battery life of the smartwatch 1.

It may be understood that, in some embodiments, the power-off condition may include at least one of the following conditions:

A received signal strength indicator (RSSI) of a Bluetooth radio frequency signal received by the smartwatch 1 is less than a preset RSSI.

A distance between a transmitting device corresponding to a Bluetooth radio frequency signal received by the smartwatch 1 and the smartwatch 1 is greater than the power-off distance R4.

The smartwatch 1 does not detect a Bluetooth radio frequency signal or a BLE radio frequency signal.

It may be understood that, in some embodiments, the lock condition may include that the distance between the smartwatch 1 and the vehicle 2 is greater than the lock distance R2.

The following further describes the technical solutions in embodiments of this disclosure with reference to scenarios shown in FIG. 6B and FIG. 6C.

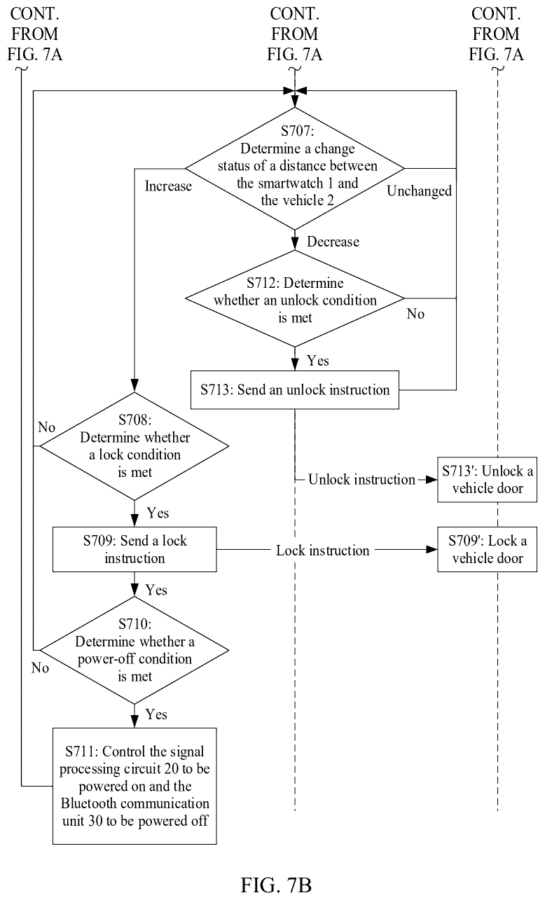

FIG. 7A and FIG. 7B are a schematic interaction flowchart of a passive keyless unlock/lock method according to some embodiments of this disclosure. As shown in FIG. 7A and FIG. 7B, the procedure includes the following steps.

S701: The vehicle 2 establishes a binding relationship with the smartwatch 1, and allocates a WUR identifier to the smartwatch 1.

The vehicle 2 establishes the binding relationship with the smartwatch 1, and allocates the WUR identifier to the smartwatch 1. The WUR identifier may uniquely identify the smartwatch 1.

In some embodiments, the vehicle 2 may first establish a communication connection to another electronic device (for example, a mobile phone), and allocate a WUR identifier to the smartwatch 1. Then, after the mobile phone establishes a connection to the smartwatch 1, the mobile phone sends, to the smartwatch 1, the WUR identifier allocated by the vehicle 2 to the smartwatch 1.

It may be understood that in some other embodiments, the vehicle 2 may directly establish a communication connection and thus a binding relationship to the smartwatch 1, and allocate a WUR identifier to the smartwatch 1.

It may be understood that in some embodiments, the WUR identifier may alternatively be other information that may identify the smartwatch 1 or the vehicle 2, for example, the foregoing verification information. This is not limited herein.

S702: The vehicle 2 embeds verification information into a broadcast frame, and periodically or continuously sends Bluetooth broadcast.

The vehicle 2 embeds the verification information into the broadcast frame of the Bluetooth broadcast, and periodically or continuously sends the Bluetooth broadcast carrying the WUR identifier.

It may be understood that the verification information may include at least one of the identification information of the smartwatch 1 and the identification information of the vehicle 2.

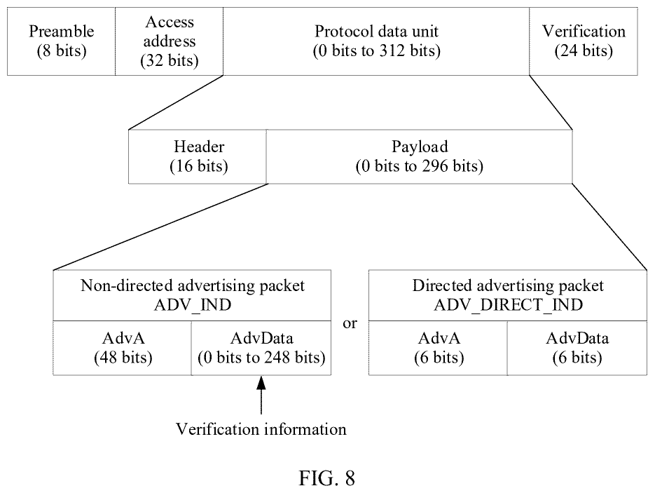

For example, refer to FIG. 8. The broadcast frame of the Bluetooth broadcast may include a preamble field, an access address field, a protocol data unit (PDU) field, and a verification (CRC) field. The protocol data unit field may be used to carry content of the Bluetooth broadcast. Further, in some embodiments, the protocol data unit field may include a header subfield and a payload subfield. A data subfield may be used to embed a non-directed advertising packet (ADV_IND) or a directed advertising packet (ADV_DIRECT_IND). In this way, the vehicle 2 may embed the verification information into the non-directed advertising packet for broadcasting. For example, a Bluetooth MAC address of the vehicle 2 may be embedded into an AdvA field of the non-directed advertising packet, and the verification information (for example, the WUR identifier of the smartwatch 1, the MAC address of the smartwatch 1, and the device serial number of the smartwatch 1) may be embedded into an AdvData field of the non-directed advertising packet. Then, the vehicle 2 periodically or continuously broadcasts a broadcast frame that carries the Bluetooth MAC address and the verification information of the vehicle 2.

It may be understood that, in some other embodiments, the vehicle 2 may alternatively embed the Bluetooth MAC address and the verification information of the vehicle 2 into another field of the broadcast frame of the Bluetooth broadcast. This is not limited herein.

S703: The smartwatch 1 listens to the Bluetooth broadcast through the signal processing circuit 20, and obtains the verification information in the Bluetooth broadcast when the Bluetooth broadcast is detected.

When the Bluetooth communication unit 30 is in sleep or powered off, the smartwatch 1 listens to the Bluetooth broadcast through the signal processing circuit 20, and obtains the verification information in the Bluetooth broadcast when the Bluetooth broadcast is detected.

For example, in some embodiments, when receiving a BLE radio frequency signal corresponding to the Bluetooth broadcast, the smartwatch 1 may first process, through the signal processing circuit 20, the BLE radio frequency signal by sequentially using a frequency mixer 22, an amplifier 23, a low-pass filter 24, an envelope detector 25, and a comparator 26, to obtain a digital signal corresponding to the BLE radio frequency signal. Then, the smartwatch 1 may demodulate, by using a baseband 28 or a processor 10, the digital signal corresponding to the BLE radio frequency signal, to obtain the broadcast frame of the Bluetooth broadcast. Finally, the verification information is obtained from a PDU field of the broadcast frame of the Bluetooth broadcast.

It may be understood that, for an example process in which the smartwatch 1 processes the BLE radio frequency signal through the signal processing circuit 20, refer to embodiments in FIG. 3, FIG. 4A, and FIG. 4B. Details are not described herein again.

S704: The smartwatch 1 determines, based on the obtained verification information, whether a wake-up condition is met.

After obtaining the verification information in the Bluetooth broadcast, the smartwatch 1 may determine, based on the verification information, whether the wake-up condition is met. If the wake-up condition is met, go to step S705. If the wake-up condition is not met, repeat step S703 to continue to listen to the Bluetooth broadcast.

It may be understood that the wake-up condition may include any one of the following conditions:

The verification information carried in the Bluetooth broadcast received by the smartwatch 1 matches the smartwatch 1.

The verification information carried in the Bluetooth broadcast received by the smartwatch 1 matches the smartwatch 1, and the distance between the smartwatch 1 and the vehicle 2 is less than the wake-up distance R3.

It may be understood that in some other embodiments, the wake-up condition may alternatively include more or fewer conditions. This is not limited herein.

For example, in some embodiments, when the WUR identifier included in the obtained verification information is the same as the WUR identifier of the smartwatch 1, the smartwatch 1 may determine that the verification information matches the smartwatch 1.

For example, in some embodiments, when the obtained verification information includes other identification information of the smartwatch 1, for example, the MAC address of the smartwatch 1 and the device serial number of the smartwatch 1, the smartwatch 1 may also determine that the verification information matches the smartwatch 1.

For example, in some embodiments, the smartwatch 1 may further record device identification information of the vehicle 2, for example, a MAC address of the vehicle 2 and a device serial number of the vehicle 2, so that when the obtained verification information includes the MAC address of the vehicle 2 and/or the device serial number of the vehicle 2, the smartwatch 1 determines that the verification information matches the smartwatch 1.

It may be understood that for different verification information, the smartwatch 1 may further determine, in another manner, whether the verification information matches the smartwatch 1. This is not limited herein.

For example, in some embodiments, the smartwatch 1 may determine a distance between the smartwatch 1 and the vehicle 2 based on a network parameter, for example, an RSSI, of a Bluetooth radio frequency signal between the smartwatch 1 and the vehicle 2.

It may be understood that, in some embodiments, the smartwatch 1 may determine, by using the baseband 28 or the processor 10, whether the wake-up condition is met.

S705: The smartwatch 1 controls the signal processing circuit 20 to be powered off and the Bluetooth communication unit 30 to be powered on.

When it is determined that the wake-up condition is met, the smartwatch 1 controls the signal processing circuit 20 to be powered off or enter a sleep state, and controls the Bluetooth communication unit 30 to be powered on or wake up the Bluetooth communication unit 30.

It may be understood that, in some embodiments, the smartwatch 1 may control, by using the baseband 28 or the processor 10, the signal processing circuit 20 to be powered off and the Bluetooth communication unit 30 to be powered on.

S706: The smartwatch 1 establishes a Bluetooth communication connection to the vehicle 2.

After controlling the Bluetooth communication unit 30 to be powered on, the smartwatch 1 establishes the Bluetooth communication connection to the vehicle 2 through the Bluetooth communication unit 30.

It may be understood that in some embodiments, the smartwatch 1 may establish a communication connection to the vehicle 2 only when it is determined that an unlock instruction or a lock instruction is to be sent to the vehicle 2. This is not limited herein.

S707: The smartwatch 1 determines a change status of the distance between the smartwatch 1 and the vehicle 2.

After the Bluetooth communication unit is powered on, the smartwatch 1 may determine the change status of the distance between the smartwatch 1 and the vehicle 2, where the change status of the distance includes distance increase, distance decrease, or distance unchanged. If the change status of the distance between the smartwatch 1 and the vehicle 2 is distance increase, go to step S708 for further determining. If the change status of the distance between the smartwatch 1 and the vehicle 2 is distance decrease, go to step S712 for further determining. If the change status of the distance between the smartwatch 1 and the vehicle 2 is distance unchanged, repeat step S707.

It may be understood that in some implementations, within preset duration, when a change amount of the distance between the smartwatch 1 and the vehicle 2 is less than a preset value, the change status of the distance between the smartwatch 1 and the vehicle 2 is distance unchanged. Within the preset duration, when an increase amount of the distance between the smartwatch 1 and the vehicle 2 is greater than or equal to the preset value, the change status of the distance between the smartwatch 1 and the vehicle 2 is distance increase. Within the preset duration, when a decrease amount of the distance between the smartwatch 1 and the vehicle 2 is greater than or equal to the preset value, the change status of the distance between the smartwatch 1 and the vehicle 2 is distance decrease.

It may be understood that, in some embodiments, the smartwatch 1 may determine, by using the processor 10, the change status of the distance between the smartwatch 1 and the vehicle 2.

S708: The smartwatch 1 determines whether a lock condition is met.

When it is determined that the change status of the distance between the smartwatch 1 and the vehicle 2 is distance increase, the smartwatch 1 determines whether the lock condition is met. If the lock condition is met, it indicates that the vehicle door of the vehicle 2 should be locked, and go to step S709. If the lock condition is not met, go to step S707.

It may be understood that, in some embodiments, the lock condition may include that the distance between the smartwatch 1 and the vehicle 2 is greater than the lock distance R2. In some other embodiments, the lock condition may alternatively include another condition. This is not limited herein.

It may be understood that, in some embodiments, the smartwatch 1 may determine, by using the processor 10, whether the lock condition is met.

S709: The smartwatch 1 sends the lock instruction to the vehicle 2.

When it is determined that the lock condition is met, the smartwatch 1 may send the lock instruction to the vehicle 2 through the Bluetooth communication connection between the smartwatch 1 and the vehicle 2.

For example, in some embodiments, the smartwatch 1 may interact with the vehicle 2 through the Bluetooth communication unit 30, to send the lock instruction to the vehicle 2.

S709′: The vehicle 2 locks the vehicle door.

After receiving the lock instruction sent by the smartwatch 1, the vehicle 2 controls, in response to the lock instruction, the vehicle door to be locked.

It may be understood that in some embodiments, after receiving the lock instruction, the vehicle 2 may further verify whether the smartwatch 1 has a lock permission, and control, in response to the lock instruction, the vehicle door to be locked only when it is determined that the smartwatch 1 has the lock permission.

S710: The smartwatch 1 determines whether a power-off condition is met.

After sending the lock instruction to the vehicle 2, the smartwatch 1 determines whether the power-off condition is met. If it is determined that the power-off condition is met, go to step S711. If it is determined that the power-off condition is not met, go to step S707 to determine the change status of the distance between the smartwatch 1 and the vehicle 2.

It may be understood that, in some embodiments, the power-off condition may include at least one of the following conditions:

The RSSI of the Bluetooth radio frequency signal that is of the vehicle 2 and that is received by the smartwatch 1 is less than a preset RSSI.

The distance between the smartwatch 1 and the vehicle 2 is greater than a power-off distance R4.

It may be understood that, in some embodiments, the smartwatch 1 may determine, by using the processor 10, whether the power-off condition is met.

S711: The smartwatch 1 controls the signal processing circuit 20 to be powered on and the Bluetooth communication unit 30 to be powered off.

When it is determined that the power-off condition is met, the smartwatch 1 controls the signal processing circuit 20 to be powered on, controls the Bluetooth communication unit 30 to be powered off or enter a sleep state, go to step S703, to listen to the Bluetooth broadcast through the signal processing circuit 20.

It may be understood that, in some embodiments, the smartwatch 1 may control, by using the processor 10, the signal processing circuit 20 to be powered on and the Bluetooth communication unit 30 to be powered off or enter a sleep state.

S712: The smartwatch 1 determines whether an unlock condition is met.

When it is determined that the change status of the distance between the smartwatch 1 and the vehicle 2 is distance decrease, the smartwatch 1 determines whether the unlock condition is met. If it is determined that the unlock condition is met, go to step S713. If it is determined that the unlock condition is not met, go to step S707 to determine the change status of the distance between the smartwatch 1 and the vehicle 2.

It may be understood that, in some embodiments, the unlock condition may include that the distance between the smartwatch 1 and the vehicle 2 is less than the unlock distance R1.

It may be understood that, in some other embodiments, the unlock condition may alternatively include another condition. This is not limited herein.

It may be understood that, in some embodiments, the smartwatch 1 may determine, by using the processor 10, whether the unlock condition is met.

S713: The smartwatch 1 sends the unlock instruction to the vehicle 2.

When it is determined that the unlock condition is met, the smartwatch 1 may send the unlock instruction to the vehicle 2 through the Bluetooth communication connection between the smartwatch 1 and the vehicle 2.

For example, in some embodiments, the smartwatch 1 may send the unlock instruction to the vehicle 2 through the Bluetooth communication unit 30.

S713′: The vehicle 2 unlocks the vehicle door.

After receiving the unlock instruction sent by the smartwatch 1, the vehicle 2 controls, in response to the unlock instruction, the vehicle door to be unlocked.

It may be understood that in some embodiments, after receiving the unlock instruction, the vehicle 2 may further verify whether the smartwatch 1 has an unlock permission, and control, in response to the unlock instruction, the vehicle door to be unlocked only when it is determined that the smartwatch 1 has the unlock permission.

According to the method provided in this embodiment of this disclosure, the Bluetooth communication unit 30 of the smartwatch 1 is woken up only when the wake-up condition is met. In addition, when the Bluetooth communication unit 30 is not woken up, the smartwatch 1 listens to the Bluetooth broadcast through the signal processing circuit 20. This helps reduce power consumption of the smartwatch 1 and improve a battery life of the smartwatch 1.

It may be understood that the foregoing introduction of the technical solutions of this disclosure by using the smartwatch 1 as an example is merely an example. In some other embodiments, the signal processing circuit 20 and the foregoing passive keyless unlock/lock method are further applicable to any other electronic device.

It may be understood that, in the foregoing embodiment, the smartwatch 1 determines when the vehicle 2 is unlocked or locked. In some other embodiments, the vehicle 2 may alternatively determine whether the vehicle is unlocked or locked, to further save power for the smartwatch 1.

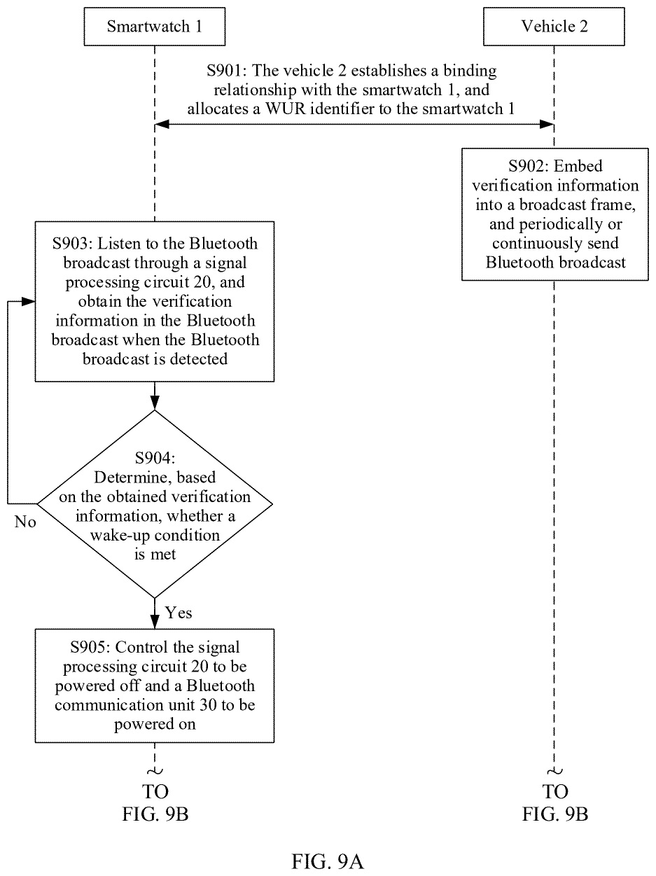

FIG. 9A and FIG. 9B are a schematic interaction flowchart of another passive keyless unlock/lock method according to some embodiments of this disclosure. As shown in FIG. 9A and FIG. 9B, the procedure includes the following steps.

S901: The vehicle 2 establishes a binding relationship with the smartwatch 1, and allocates a WUR identifier to the smartwatch 1.

The vehicle 2 establishes the binding relationship with the smartwatch 1, and allocates the WUR identifier to the smartwatch 1. The WUR identifier may uniquely identify the smartwatch 1. For an example manner in which the vehicle 2 allocates the WUR identifier to the smartwatch 1, refer to step S901. Details are not described herein again.

S902: The vehicle 2 embeds verification information into a broadcast frame, and periodically or continuously sends Bluetooth broadcast.

The vehicle 2 embeds the verification information into the broadcast frame of the Bluetooth broadcast, and periodically or continuously sends the Bluetooth broadcast carrying the WUR identifier. For the verification information and a manner of embedding the verification information into the broadcast frame of the Bluetooth broadcast, refer to step S702. Details are not described herein.

S903: The smartwatch 1 listens to the Bluetooth broadcast through the signal processing circuit 20, and obtains the verification information in the Bluetooth broadcast when the Bluetooth broadcast is detected.

When the Bluetooth communication unit 30 is in sleep or powered off, the smartwatch 1 listens to the Bluetooth broadcast through the signal processing circuit 20, and obtains the verification information in the Bluetooth broadcast when the Bluetooth broadcast is detected. For an example manner in which the smartwatch 1 obtains the verification information, refer to step S903. Details are not described herein again.

S904: The smartwatch 1 determines, based on the obtained verification information, whether a wake-up condition is met.

After obtaining the verification information in the Bluetooth broadcast, the smartwatch 1 may determine, based on the verification information, whether the wake-up condition is met. If the wake-up condition is met, go to step S905. If the wake-up condition is not met, repeat step S903 to continue to listen to the Bluetooth broadcast. For example, content of the wake-up condition and a manner in which the smartwatch 1 determines whether the wake-up condition is met, refer to step S904. Details are not described herein again.

S905: The smartwatch 1 controls the signal processing circuit 20 to be powered off and the Bluetooth communication unit 30 to be powered on.

When it is determined that the wake-up condition is met, the smartwatch 1 controls the signal processing circuit 20 to be powered off or enter a sleep state, and controls the Bluetooth communication unit 30 to be powered on or wake up the Bluetooth communication unit 30.

It may be understood that, in some embodiments, the smartwatch 1 may control, by using the baseband 28 or the processor 10, the signal processing circuit 20 to be powered off and the Bluetooth communication unit 30 to be powered on.

S906: The smartwatch 1 establishes a Bluetooth communication connection to the vehicle 2.

After the Bluetooth communication unit 30 is powered on, the smartwatch 1 establishes a communication connection to the vehicle 2 through the Bluetooth communication unit 30.

S907: The vehicle 2 locks or unlocks the vehicle door based on a distance between the vehicle 2 and the smartwatch 1.

After establishing the Bluetooth communication connection to the smartwatch 1, the vehicle 2 locks or unlocks the vehicle door based on the distance between the vehicle 2 and the smartwatch 1.

For example, when it is determined that the lock condition is met, the vehicle 2 may control the vehicle door to be locked. For example, when the distance between the vehicle 2 and the smartwatch 1 is greater than a lock distance R2 (for example, the smartwatch 1 is located at point C in FIG. 6C), the vehicle 2 controls the vehicle door to be locked.

For example, when it is determined that the unlock condition is met, the vehicle 2 may control the vehicle to be unlocked. For example, when the distance between the vehicle 2 and the smartwatch 1 is less than an unlock distance R1 (that is, the user is located at point B in FIG. 6B), the vehicle 2 controls the vehicle door to be unlocked.

S908: The smartwatch 1 determines whether a power-off condition is met.

After establishing the Bluetooth communication connection to the vehicle 2, the smartwatch 1 determines whether the power-off condition is met. If it is determined that the power-off condition is met, go to step S909. If it is determined that the power-off condition is not met, repeat step S908.

It may be understood that, in some embodiments, the power-off condition may include at least one of the following conditions:

The RSSI of the Bluetooth radio frequency signal that is of the vehicle 2 and that is received by the smartwatch 1 is less than a preset RSSI.

The distance between the smartwatch 1 and the vehicle 2 is greater than a power-off distance R4.

The smartwatch 1 does not detect a Bluetooth radio frequency signal.

It may be understood that, in some embodiments, the smartwatch 1 may determine, by using the processor 10, whether the power-off condition is met.

S909: The smartwatch 1 controls the signal processing circuit 20 to be powered on and the Bluetooth communication unit 30 to be powered off.

When it is determined that the power-off condition is met, the smartwatch 1 controls the signal processing circuit 20 to be powered on, controls the Bluetooth communication unit 30 to be powered off or enter a sleep state, go to step S903, to listen to the Bluetooth broadcast through the signal processing circuit 20.

It may be understood that, in some embodiments, the smartwatch 1 may control, by using the processor 10, the signal processing circuit 20 to be powered on and the Bluetooth communication unit 30 to be powered off or enter a sleep state.

It may be understood that, in some embodiments, step S908 and step S907 may be performed simultaneously.

According to the method provided in this embodiment of this disclosure, the Bluetooth communication unit 30 of the smartwatch 1 is woken up only when the wake-up condition is met. In addition, when the Bluetooth communication unit 30 is not woken up, the smartwatch 1 listens to the Bluetooth broadcast through the signal processing circuit 20. This helps reduce power consumption of the smartwatch 1 and improve a battery life of the smartwatch 1. In addition, the vehicle 2 determines whether to unlock/lock the vehicle door, so that power consumption of the smartwatch 1 can be further reduced, and a battery life of the smartwatch 1 can be improved.

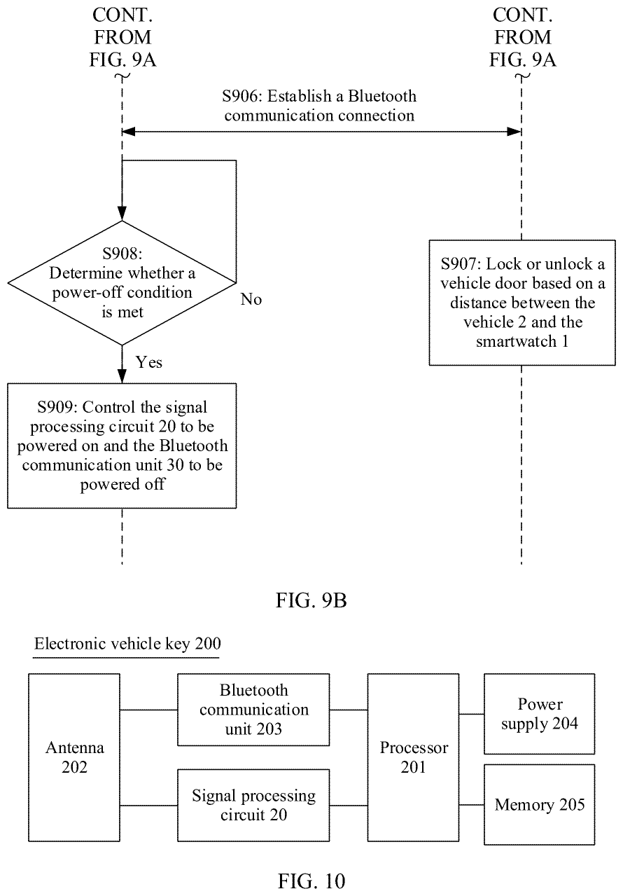

For example, FIG. 10 is a diagram of a structure of an electronic vehicle key 200 according to some embodiments of this disclosure.

As shown in FIG. 10, the electronic vehicle key 200 includes a signal processing circuit 20, a processor 201, an antenna 202, a Bluetooth communication unit 203, a power supply 204, and a memory 205.

The signal processing circuit 20 is configured to: receive a radio frequency signal (for example, a Bluetooth radio frequency signal obtained through modulation by using a scheme such as 2FSK or 2GFSK), and sequentially process the radio frequency signal by using a frequency mixer 22, an amplifier 23, a low-pass filter 24, an envelope detector 25, and a comparator 26, to obtain a digital signal corresponding to the radio frequency signal. For an example processing process, refer to the descriptions in FIG. 3, FIG. 4A, and FIG. 4B. Details are not described herein again.

The processor 201 is configured to: demodulate the digital signal obtained by the signal processing circuit 20, to obtain information carried in the digital signal, and when the information carried in the digital signal includes verification information that matches the electronic vehicle key 200, wake up the Bluetooth communication unit 203 and power off the signal processing unit 20. After waking up the Bluetooth communication unit 203, the processor 201 may further determine that the electronic vehicle key 200 interacts with an electronic device (for example, the vehicle 2) that transmits the radio frequency signal.

It may be understood that the processor 201 may be a general-purpose processor, or may be a low-power processor such as an FPGA, an MCU, or an ASIC, to further reduce power consumption of the electronic vehicle key 200. In some embodiments, the processor 201 may be further configured to: execute instructions stored in the memory 205, to perform the following operations: when it is determined that the unlock condition (a distance between the electronic vehicle key 200 and the vehicle 2 is less than an unlock distance R1) is met, send an unlock instruction to the vehicle 2 through the Bluetooth communication unit 203; or when the lock condition (the distance between the electronic vehicle key 200 and the vehicle 2 is greater than a lock distance R2) is met, send a lock instruction to the vehicle 2 through the Bluetooth communication unit 203; or when it is determined that the power-off condition is met, control the Bluetooth communication unit 203 to be powered off and the signal processing circuit 20 to be powered on. For an example process, refer to the embodiment shown in FIG. 7A and FIG. 7B. This is not limited herein.

The Bluetooth communication unit 203 is configured to perform Bluetooth communication with another electronic device. For details, refer to the foregoing descriptions of the Bluetooth communication unit 30. This is not limited herein.

The power supply 204 is configured to supply power to the processor 201, the antenna 202, the Bluetooth communication unit 203, and the memory 205.

The memory 205 is configured to store instructions and data.

It may be understood that, in some embodiments, the Bluetooth communication unit 203 and the signal processing circuit 20 may be coupled to the antenna 202 through a matching circuit (not shown), so that the antenna 202 can adapt to impedance of the Bluetooth communication unit 203 and the signal processing circuit 20 through the matching circuit, to reduce signal interference.

Based on the electronic vehicle key 200 of the signal processing circuit 20, because the amplifier 23 is disposed behind the frequency mixer 22, amplification of a high-frequency radio frequency signal can be avoided. This helps reduce power consumption of the signal processing circuit 20, thereby reducing power consumption of the electronic vehicle key 200. In addition, the signal processing circuit 20 filters out a high-frequency signal by using the low-pass filter 24, so that only a signal of only one frequency that corresponds to the digital circuit and that is in a low-pass filtered signal may need to be processed, which is equivalent to converting a signal obtained through modulation by using 2GFSK into a signal obtained through modulation by using the OOK modulation scheme, and may not need to process a high-frequency signal in the signal obtained through modulation by using 2GFSK. This reduces a quantity of filters and envelope detectors, and further reduces power consumption of the electronic vehicle key 200 because a signal processed by the signal processing circuit 20 is a low-frequency signal.

It may be understood that the structure of the electronic vehicle key 200 is merely an example. In some other embodiments, the electronic vehicle key 200 may include more or fewer modules. This is not limited herein.

An embodiment of this disclosure further provides a chip. The chip includes the signal processing circuit 20.

Embodiments of mechanisms disclosed in this disclosure may be implemented in hardware, software, firmware, or a combination of these implementation methods. Embodiments of this disclosure may be implemented as a computer program or program code executed in a programmable system. The programmable system includes at least one processor, a storage system (including a volatile memory, a non-volatile memory, and/or a storage element), at least one input device, and at least one output device.

The program code may be applied to input instructions to perform the functions described in this disclosure and generate output information. The output information may be applied to one or more output devices in a known manner. For a purpose of this disclosure, a processing system includes any system having a processor such as a digital signal processor (DSP), a microcontroller, an application-specific integrated circuit (ASIC), or a microprocessor.

The program code may be implemented in a high-level programming language or an object-oriented programming language to communicate with the processing system. The program code may alternatively be implemented by using an assembly language or a machine language in some instances. The mechanisms described in this disclosure are not limited to the scope of any particular programming language. In any case, the language may be a compiled language or an interpretive language.

In some cases, the disclosed embodiments may be implemented in hardware, firmware, software, or any combination thereof. The disclosed embodiments may alternatively be implemented as instructions that are carried or stored on one or more transitory or non-transitory machine-readable (for example, computer-readable) storage media and that may be read and executed by one or more processors. For example, the instructions may be distributed through a network or another computer-readable medium. Therefore, the machine-readable medium may include any mechanism for storing or transmitting information in a machine (for example, a computer) readable form, including but not limited to a floppy disk, a compact disc, an optical disc, a read-only memory (CD-ROMs), a magnetic optical disk, a read-only memory (ROM), a random access memory (RAM), an erasable programmable read-only memory (EPROM), an electrically erasable programmable read-only memory (EEPROM), a magnetic card, an optical card, a flash memory, or a tangible machine-readable memory used to transmit information (for example, a carrier, an infrared signal, or a digital signal) by using a propagating signal in an electrical, optical, acoustic, or another form over the Internet. Therefore, the machine-readable medium includes any type of machine-readable medium suitable for storing or transmitting an electronic instruction or information in a machine (namely, computer)-readable form.

In the accompanying drawings, some structural or method features may be shown in a particular arrangement and/or order. However, it should be understood that such a particular arrangement and/or sequence may not be required. In some embodiments, these features may be arranged in a manner and/or order different from those/that shown in the descriptive accompanying drawings. In addition, inclusion of the structural or method features in a particular figure does not imply that such features may be needed in some embodiments, and in some embodiments, these features may not be included or may be combined with other features.

It should be noted that all units/modules mentioned in device embodiments of this disclosure are logical units/modules. Physically, one logical unit/module may be one physical unit/module, may be a part of one physical unit/module, or may be implemented by using a combination of a plurality of physical units/modules. Physical implementations of these logical units/modules are not the most important, and a combination of functions implemented by these logical units/modules is a key to resolve the technical problem provided in this disclosure. In addition, to highlight an innovative part of this disclosure, a unit/module that is not closely related to resolving the technical problem provided in this disclosure is not described in the foregoing device embodiments of this disclosure. This does not mean that there are no other units/modules in the foregoing device embodiments.

It should be noted that, in the examples and specification of this patent, relational terms such as first and second are merely used to distinguish one entity or operation from another, and do not necessarily require or imply any such actual relationship or order between these entities or operations. Moreover, the term “include” or any other variant thereof is intended to cover a non-exclusive inclusion, so that a process, a method, an article, or a device that includes a list of elements not only includes those elements but also includes other elements that are not expressly listed, or further includes elements inherent to such a process, method, article, or device. Without further limitations, an element limited by “include a/an” does not exclude other same elements existing in the process, the method, the article, or the device which includes the element.

Although this disclosure has been illustrated and described with reference to some preferred embodiments of this disclosure, a person of ordinary skill in the art should understand that various changes may be made to this disclosure in form and detail without departing from the spirit and scope of this disclosure.

What is claimed is:

1. A method comprising:
receiving a radio frequency signal comprising:
a first frequency signal corresponding to a first digital signal and comprising a first frequency; and
a second frequency signal corresponding to a second digital signal and comprising
a second frequency lower than the first frequency;
performing frequency mixing on the radio frequency signal to obtain a mixed signal comprising:
a third frequency signal corresponding to the first frequency signal; and
a fourth frequency signal corresponding to the second frequency signal;
filtering out the third frequency signal from the mixed signal to obtain a filtered signal; and
obtaining, based on the filtered signal, a third digital signal corresponding to the radio frequency signal.

2. The method of claim 1, wherein when information in the third digital signal meets a wake-up condition, the method further comprises:
waking up a Bluetooth communicator; or
controlling the Bluetooth communicator to be powered on.

3. The method of claim 2, wherein the wake-up condition comprises any one of:
the information comprises verification information matching an electronic device and comprising any one of:
a first media access control (MAC) address of the electronic device;
a first device serial number of the electronic device;
a wake-up radio identifier of the electronic device;
a second MAC of a vehicle; or
a second device serial number of the vehicle; or
the information comprises the verification information matching the electronic device, and a second distance between the electronic device and the vehicle is less than a first distance.

4. The method of claim 2, wherein when a power-off condition is met, the method further comprises:
powering off the Bluetooth communicator;
placing the Bluetooth communicator in a sleep state;
powering on a signal processing circuit; or
waking up the signal processing circuit.

5. The method of claim 4, wherein the power-off condition comprises at least one of:
a received signal strength indicator (RSSI) of the radio frequency signal is less than a preset RSSI;
a first distance between a vehicle and an electronic device comprising the signal processing circuit is greater than a second distance; or
no detection of a Bluetooth radio frequency signal or a Bluetooth Low Energy radio frequency signal.

6. The method of claim 2, further comprising:
sending, when a first distance between a vehicle and an electronic device comprising the Bluetooth communicator is less than a third distance, an unlock instruction to the vehicle; and
sending, when the first distance between the electronic device and the vehicle is greater than a fourth distance, a lock instruction to the vehicle.

7. A signal processing circuit comprising:
a frequency mixer configured to:
receive a radio frequency signal;
perform frequency mixing on the radio frequency signal and a local oscillator signal to obtain a mixed signal comprising a first frequency signal comprising a first frequency and corresponding to a first digital signal and a second frequency signal comprising a second frequency less than the first frequency and corresponding to a second digital signal; and
output the mixed signal;
an amplifier connected to the frequency mixer and configured to:
amplify the mixed signal to obtain an amplified signal; and
output the amplified signal;
a low-pass filter connected to the amplifier and configured to:
filter the amplified signal to obtain a filtered signal; and
output the filtered signal, wherein a cut-off frequency of the low-pass filter is less than the first frequency and greater than the second frequency;
an envelope detector connected to the low-pass filter and configured to:
perform envelope detection on the filtered signal to obtain an envelope signal; and
output the envelope signal; and
a comparator connected to the envelope detector and configured to:
compare the envelope signal with a reference signal to obtain a comparison result; and
output an output digital signal corresponding to the radio frequency signal and based on the comparison result.

8. The signal processing circuit of claim 7, wherein the first frequency signal and the second frequency signal correspond to opposite digital signal values.

9. The signal processing circuit of claim 7, wherein the radio frequency signal is modulated based on a binary frequency-shift keying scheme or a binary Gauss frequency-shift keying scheme.

10. The signal processing circuit of claim 7, wherein the radio frequency signal is a Bluetooth radio frequency signal or a Bluetooth Low Energy radio frequency signal.

11. The signal processing circuit of claim 10, wherein the cut-off frequency is 250 kilohertz (kHz).

12. The signal processing circuit of claim 11, wherein the output digital signal is 1 when the comparison result is that the envelope signal is greater than the reference signal and the output digital signal is 0 when the comparison result is that the envelope signal is less than the reference signal, or wherein the output digital signal is 0 when the comparison result is that the envelope signal is greater than the reference signal and the output digital signal is 1 when the comparison result is that the envelope signal is less than the reference signal.

13. The signal processing circuit of claim 7, wherein the envelope detector is further configured to perform the envelope detection using binary on-off keying.

14. An electronic device comprising:
an antenna;
a signal processing circuit comprising:
a frequency mixer configured to:
receive a radio frequency signal; and
perform frequency mixing on the radio frequency signal and a local oscillator signal to obtain a mixed signal comprising a first frequency signal comprising a first frequency and corresponding to a first digital signal and a second frequency signal comprising a second frequency less than the first frequency and corresponding to a second digital signal; and
output the mixed signal;
an amplifier connected to the frequency mixer and configured to:
amplify the mixed signal to obtain an amplified signal; and
output the amplified signal;
a low-pass filter connected to the amplifier and configured to:
filter the amplified signal to obtain a filtered signal; and
output the filtered signal, wherein a cut-off frequency of the low-pass filter is less than the first frequency and greater than the second frequency;
an envelope detector connected to the low-pass filter and configured to:
perform envelope detection on the filtered signal to obtain an envelope signal; and
output the envelope signal; and
a comparator connected to the envelope detector and configured to:
compare the envelope signal with a reference signal to obtain a comparison result; and
output an output digital signal corresponding to the radio frequency signal and based on the comparison result; and
a matching circuit connected to the antenna and the signal processing circuit and configured to match impedance between the antenna and the signal processing circuit.

15. The electronic device of claim 14, further comprising:
a Bluetooth communicator; and
at least one processor configured to:
demodulate information carried in the output digital signal; and
when the information carried in the output digital signal meets a wake-up condition, wake up the Bluetooth communicator or power on the Bluetooth communicator.

16. The electronic device of claim 15, wherein the wake-up condition comprises any one of:
the information comprises verification information matching the electronic device and comprising any one of:
a first MAC address of the electronic device;
a first device serial number of the electronic device;
a wake-up radio identifier of the electronic device;
a second MAC address of a vehicle; or
a second device serial number of the vehicle; or
the information comprises the verification information matching the electronic device, and a distance between the electronic device and the vehicle is less than a first distance.

17. The electronic device of claim 16, wherein the at least one processor is further configured to:
when the distance between the electronic device and the vehicle is less than a second distance, send an unlock instruction to the vehicle through the Bluetooth communicator; and
when the distance between the electronic device and the vehicle is greater than a third distance, send a lock instruction to the vehicle through the Bluetooth communicator.

18. The electronic device of claim 15, wherein the at least one processor is further configured to, based on meeting a power-off condition:
power off the Bluetooth communicator;
place the Bluetooth communicator in a sleep state;
power on the signal processing circuit; or
wake up the signal processing circuit.

19. The electronic device of claim 18, wherein the power-off condition comprises at least one of:
a received signal strength indicator (RSSI) of the radio frequency signal is less than a preset RSSI;
a distance between the electronic device and a vehicle is greater than a first distance; or
no detection of a Bluetooth radio frequency signal or a Bluetooth Low Energy radio frequency signal.

20. The electronic device of claim 14, wherein the first frequency signal and the second frequency signal correspond to opposite digital signal values.
